(19) United States
(12) Patent Application Publication
(10) Pub. No.: US 2005/0098981 A1
(43) Pub. Date: May 12, 2005

(54) Folding joint structure for strollers

(75) Inventor: Ling-Chuan Chang, Chia-I City (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 10/983,055

(22) Filed: Nov. 8, 2004

(30) Foreign Application Priority Data
Nov. 9, 2003 (CN) 200320120892.6

(51) Int. Cl. B62B 7/08

(52) U.S. Cl. 280/642

(57) ABSTRACT

A folding joint structure for strollers to control extension, anchoring, release and folding of the stroller frame includes an outer joint and an inner joint coupled to the frame. When the frame is extended, the outer joint covers the inner joint so that there is no gap formed therebetween when the handle tube of the frame is pushed downwards. Therefore injury to the baby's hands may be prevented and wobbling of the joint assembly may be reduced.

### FIELD OF THE INVENTION

The invention relates to a folding joint structure for strollers that has an outer joint to cover an inner joint while the frame of a stroller is extended to prevent a gap from forming that might injure a baby's hands.

### BACKGROUND OF THE INVENTION

The purpose of a stroller is mainly to carry a baby. In order to reduce the storage space and facilitate transportation when not in use, the frame of the stroller generally has a joint assembly that may be latched and released to extend the frame in a use condition and collapse the frame in a folding condition. Refer to FIG. 1 for a conventional stroller frame 10. It mainly includes a handle tube 11, a front leg tube 12, a rear leg tube 13, a seat tube 14 and a joint assembly 15 that are pivotally coupled with one another. The joint assembly 15 bridges the handle tube 11 and the front leg tube 12, and includes an upper latch member 151 and a lower latch member 152. By coupling the upper latch member 151 and the lower latch member 152, the frame 10 may be extended to the use condition. The handle tube 11 further has a release device 16 to drive the joint assembly 15 to release the latch condition of the upper latch member 151 and the lower latch member 152 so that the frame 10 may be collapsed to a folding condition.

The joint assembly 15 of the conventional stroller frame 10 has to reserve an allowance for the latching of the upper latch member 151 and the lower latch member 152. Hence when coupled, the joint assembly 15 tends to wobble. Moreover, when the handle tube 11 is pushed downwards, the upper latch member 151 and the lower latch member 152 tend to form a gap (referring to FIG. 2) that can be reached by the baby while sitting. This creates a risk of injuring the baby's hands.

### SUMMARY OF THE INVENTION

In view of the aforesaid problems occurring to the joint assembly of the conventional stroller, which tends to form a gap when the handle tube is pushed downwards and results in a risk of injuring the baby's hands, the primary object of the invention is to provide a joint assembly that has an outer joint and an inner joint so that the outer joint can cover the inner joint when the frame is extended to thereby prevent a gap from forming and eliminate the risk of injuring the baby's hands.

The foregoing, as well as additional objects, features and advantages of the invention will be more readily apparent from the following detailed description, which proceeds with reference to the accompanying drawings. The descriptions and drawings are for illustrative purposes only, and are not limitative of the invention.

### BRIEF DESCRIPTION OF THE DRAWINGS

FIG. 1 is a schematic view of the joint assembly of a conventional stroller.

FIG. 2 is a schematic view of the joint assembly of a conventional stroller forming a gap while the handle tube is pushed downwards that might injure the baby's hands.

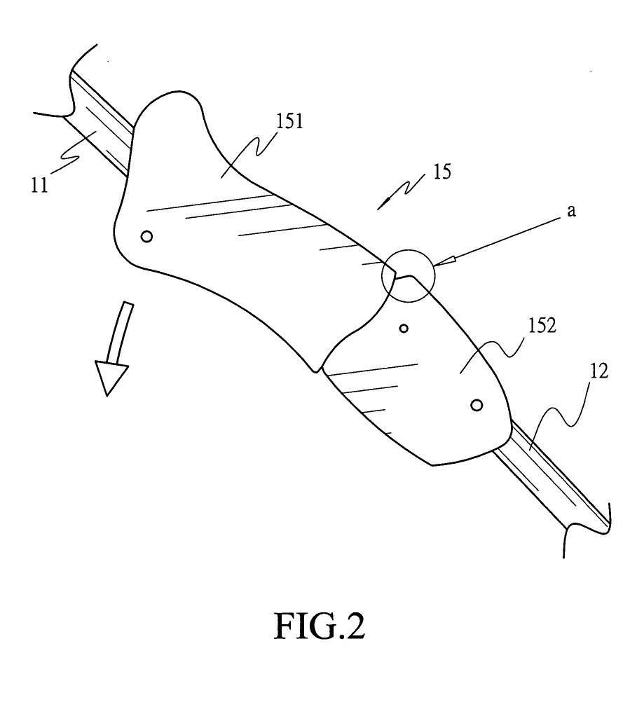

FIG. 3 is a schematic view of the invention installed on a stroller frame.

FIG. 4 is an exploded view of the joint assembly of the invention.

FIG. 5 is a sectional view of the joint assembly.

FIG. 6 is a schematic view of the pulling hook of the invention.

FIG. 7 is schematic view of the stroller frame in a folding condition.

FIG. 8 is a sectional view of the joint assembly after coupling.

### DESCRIPTION OF THE PREFERRED EMBODIMENTS

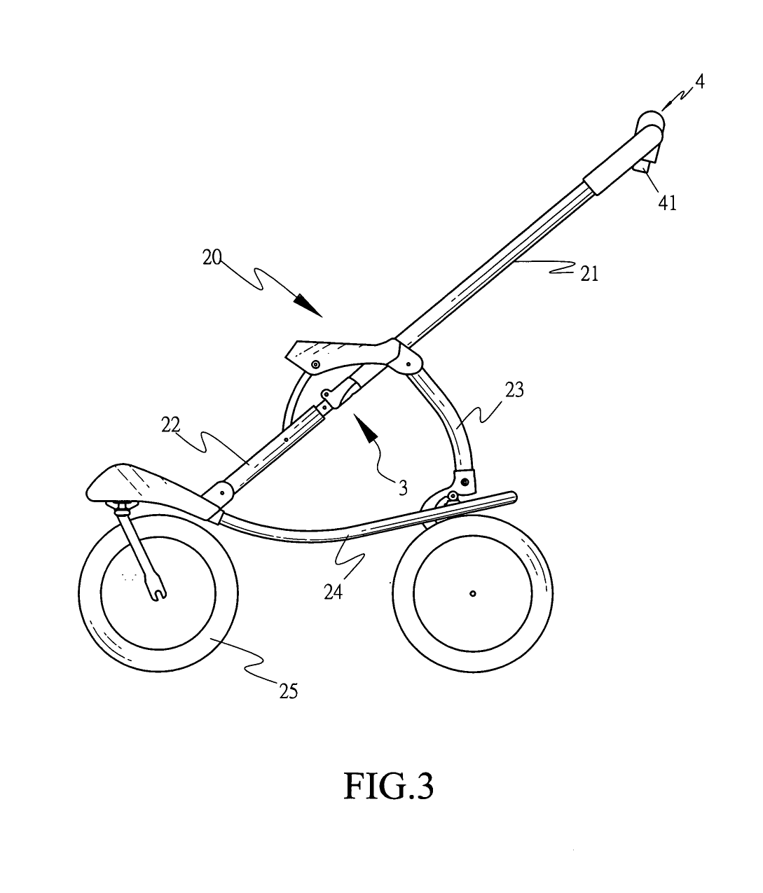

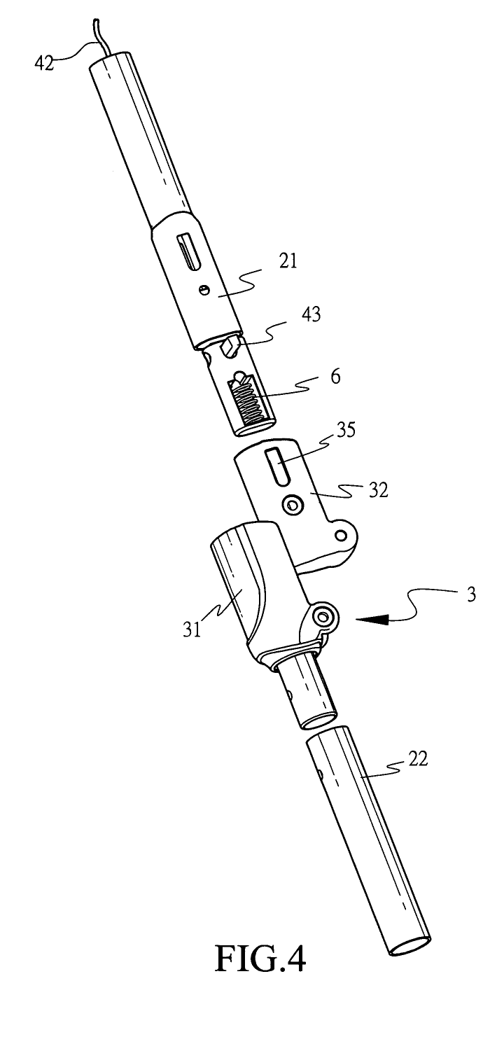

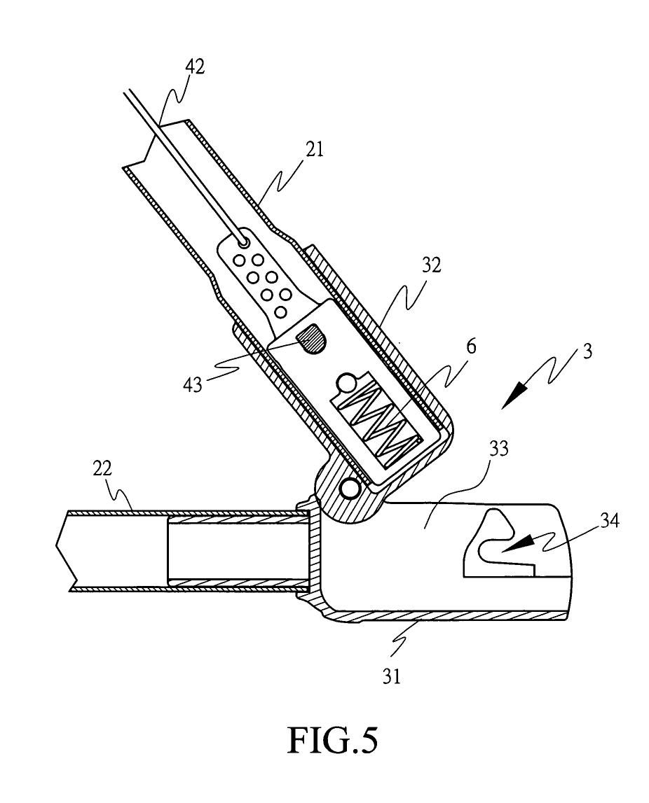

Referring to FIGS. 3, 4 and 5, the folding joint structure for strollers according to the invention is installed on a frame 20 to control extending and folding thereof. The structure of the invention includes the frame 20, a folding controller 4 and a joint assembly 3.

The frame 20 mainly includes a handle tube 21, a front leg tube 22, a rear leg tube 23, a bottom tube 25, the joint assembly 3 and the folding controller 4. The frame 20 is movable and foldable, and may be unfolded to an extended condition through the joint assembly 3 (referring to FIG. 3). The joint assembly 3 may be latched and released through the folding controller 4.

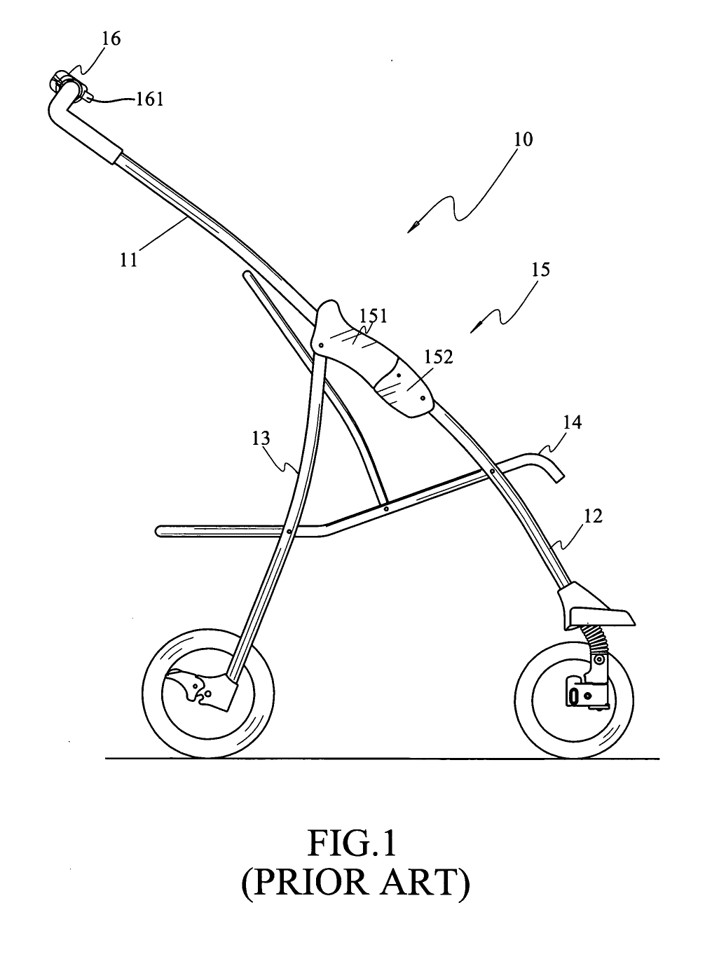

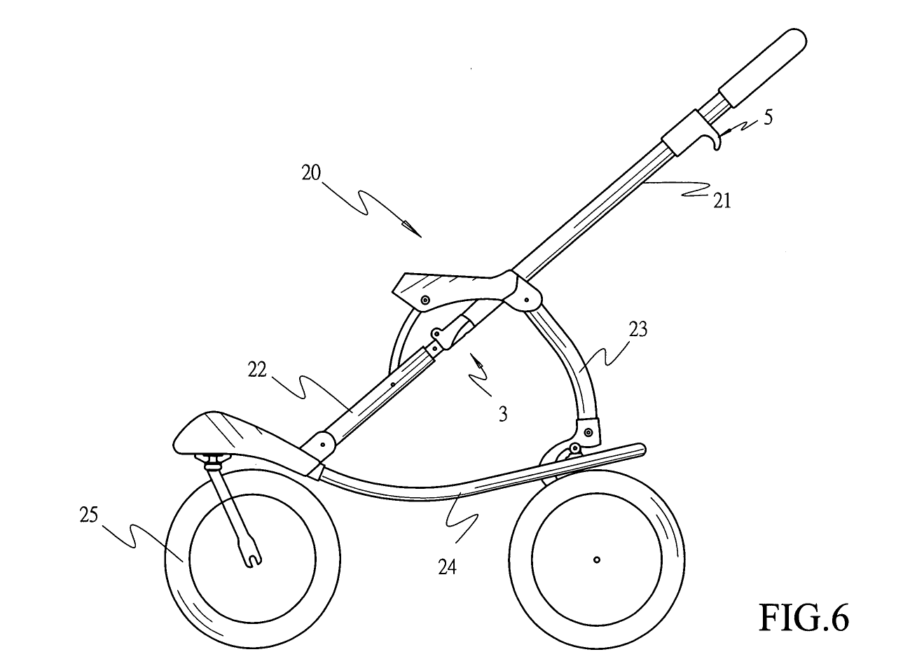

The folding controller 4 includes a release structure 41, a pair of linkage members 42 and a movable latch finger 43. The release structure 41 is located on the handle tube 21, and may adopt that provided in the prior art (referring to the release structure 161 of the release device 16 in FIG. 1). Otherwise, pulling hooks 5 may be provided on two sides of the handle tube 21 (referring to FIG. 6) to function as the release structure. The linkage members 42 (may be steel cables, iron wires, or the like) bridge the release structure 41 and the movable latch finger 43 to move the movable latch finger 43 through the release structure 41.

The joint assembly 3 includes an outer joint 31 and a lower joint 32. The outer joint 31 is coupled on an upper end of the front leg tube 22 and has a housing space 30 for holding the inner joint 32. The outer joint 31 further has an inner wall 33 containing an integrated anchor section 34. The inner joint 32 has one end pivotally coupled on the outer joint 31 and another end connecting to a lower end of the handle tube 21. The inner joint 32 has a slot 35 formed respectively on two sides to allow the movable latch finger 43 to run through and move in the handle tube 21 and the inner joint 32.

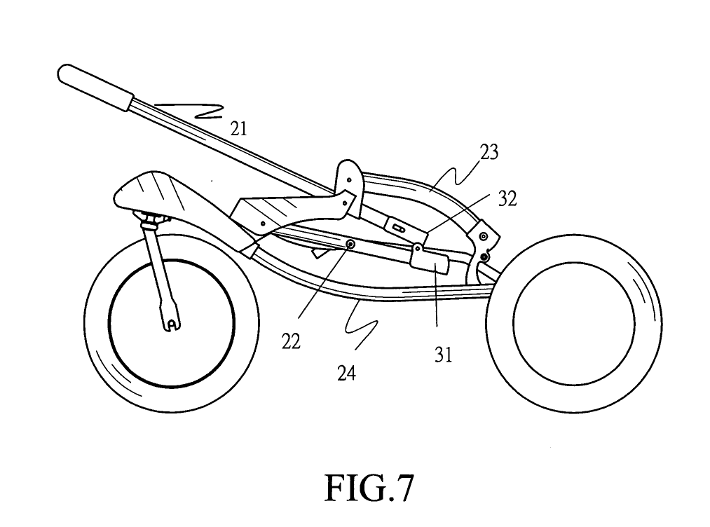

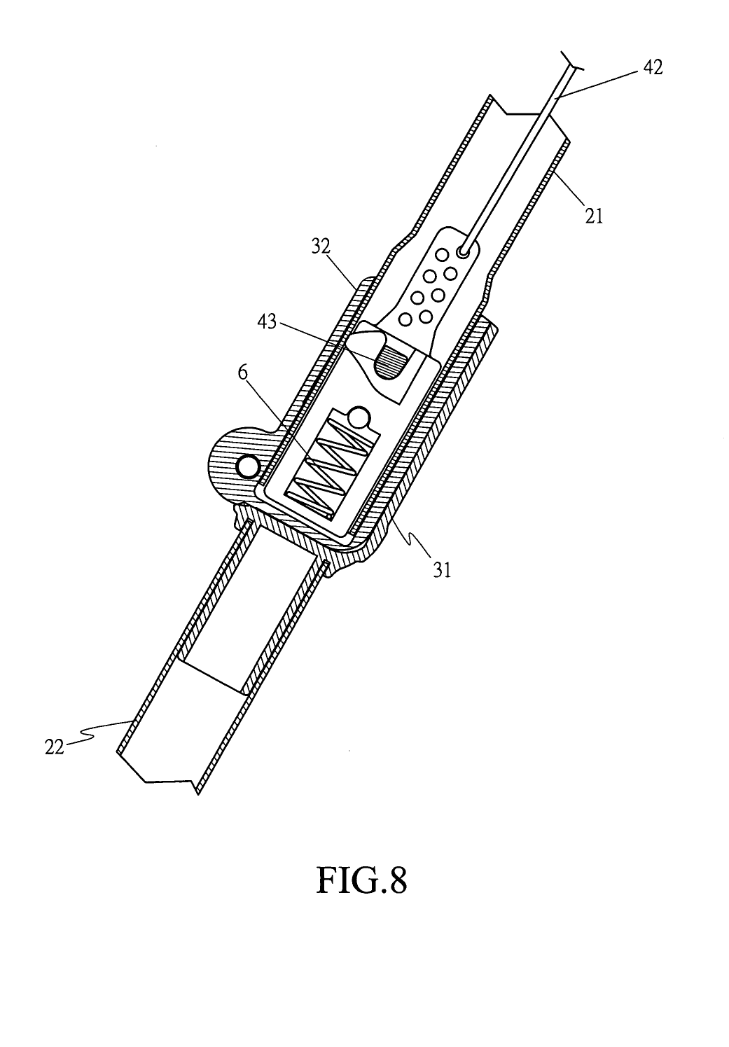

When the frame 20 is extended, the handle tube 21 is turned, and the inner joint 32 is driven to enter the housing space 30 of the outer joint 31 and be covered by the outer joint 31. Meanwhile, the movable latch finger 43 enters the anchor section 34 of the outer joint 31 to form a latch condition. An elastic element 6 is provided to keep the movable latch finger 43 in the latch condition so that the frame 20 is extended and anchored in a use condition (referring to FIGS. 3 and 8). Folding of the frame 20 is accomplished by driving the linkage members 42 through the release structure 41 so that the movable latch finger 43 is moved away from the anchor section 34 of the outer joint 31, and the handle tube 21 may be moved forwards to drive other tubular members and collapse the frame 20 in a folding condition, as shown in FIG. 7.

By means of the construction set forth above, when the frame is in the extended condition, the inner joint is covered by the outer joint. Therefore when the handle tube is pushed downwards, no gap is formed and injury to the baby's hands may be avoided.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A folding joint structure for strollers, coupling a frame of a stroller to provide a joint function for extending or folding the frame, comprising:
an inner joint, having one end coupled on the frame, and another end fastened to a movable latch finger; and
an outer joint, having one end coupled on the frame and another end pivotally coupled with the inner joint for holding the inner joint, and an anchor section located on an inner wall thereof to engage with the movable latch finger to allow the frame coupled by the outer joint and the inner joint to form an anchor condition.

2. The folding joint structure for strollers of claim 1, wherein the frame includes a handle tube, a front leg tube, a rear leg tube.

3. The folding joint structure for strollers of claim 1, wherein the movable latch finger is moved to escape the anchor section by driving a linkage member through a release structure.

4. The folding joint structure for strollers of claim 3, wherein the release structure is operable single-handed.

5. The folding joint structure for strollers of claim 3, wherein the release structure includes pulling hooks located on two sides of the handle tube.

6. The folding joint structure for strollers of claim 1, wherein the anchor section is extended from the inner wall surface of the outer joint.

7. The folding joint structure for strollers of claim 1, wherein the movable latch finger runs through the handle tube and the inner joint.

8. The folding joint structure for strollers of claim 1, wherein the movable latch finger is engaged with the anchor section to maintain the anchor condition through an elastic element.

9. The folding joint structure for strollers of claim 1, wherein the linkage member is a steel cable.

10. A folding joint structure for strollers, comprising:
a stroller frame, which includes a front leg tube, a rear leg tube and a handle tube, the handle tube having a lower end fastened to a movable latch finger which is movable through a release structure; and
a joint assembly, which includes an inner joint and an outer joint, the outer joint being fixedly coupled on a upper end of the front leg tube and having an anchor section formed on an inner wall thereof, the inner joint having one end fixedly coupled on the lower end of the handle tube and another end pivotally coupled on the outer joint, the movable latch finger running through the inner joint such that the inner joint is turned and housed in the outer joint in an overlapped manner when the frame is extended and the movable latch finger is latched on the anchor section to anchor the stroller frame in an extending condition.
